(19) United States
(12) Patent Application Publication
(10) Pub. No.: US 2024/0002235 A1
(43) Pub. Date: Jan. 4, 2024

(54) GRAPHENE PRODUCTION METHOD

(71) Applicant: LIG Nanowise Limited, Birmingham (GB)

(72) Inventors: Lin Li, Stockport (GB); Yihe Huang, Salford (GB)

(21) Appl. No.: 18/039,894

(22) PCT Filed: Dec. 2, 2021
(86) PCT No.: PCT/GB2021/053154

§ 371 Date: Jun. 1, 2023

(30) Foreign Application Priority Data
Dec. 2, 2020 (GB) 2019010.4

(51) Int. Cl. C01B 32/19

(52) U.S. Cl. CPC C01B 32/19; C01B 2204/32; C01P 2006/14; C01P 2004/61

(57) ABSTRACT

This disclosure relates to a method for producing graphene, the method comprising the steps of providing a polymeric graphene precursor comprising one or more donor atoms, subjecting the polymeric graphene precursor to a bulk thermal heat treatment to produce graphene and subjecting the graphene obtained from the bulk thermal heat treatment to one or more mechanical exfoliation treatments, wherein the one or more exfoliation treatments comprises ball milling.

### CROSS-REFERENCE TO RELATED APPLICATIONS

This application is a national stage of International Application No. PCT/GB2021/053154, filed on Dec. 2, 2021, which claims priority to United Kingdom Patent Application No. 2019010.4, filed on Dec. 2, 2020. The disclosures of both of the aforementioned applications are hereby incorporated by reference in their entireties.

### TECHNICAL FIELD

The present disclosure relates to a method for producing graphene, to the graphene thus produced and to the use of the graphene produced by said method. In particular, the disclosure relates to a method for producing doped graphene.

### BACKGROUND

There are many commercial approaches for producing graphene including mechanical exfoliation, liquid-phase exfoliation, epitaxial growth of graphene on silicon carbide and chemical vapour deposition.

Graphite is composed of multiple graphene sheets, bonded together via weak Van der Waals forces. Therefore, if these bonds break, high purity graphene sheets can be obtained. Mechanical exfoliation may be utilised to overcome the Van der Waals forces and one common approach is to dry etch a highly oriented pyrolytic graphite (HOPG) sheet using plasma. Graphene present on a photoresist is peeled off using scotch tape and single or few layer graphene flakes are released before they are transferred to a silicon substrate. While this method is reliable and enables good quality graphene to be obtained with few defects, this approach is labour intensive and involves multiple steps. Moreover, the graphene obtained is hydrophobic which makes it difficult to mix with and incorporate into polymer materials which are typically used in composite and coatings applications for example.

Another method for producing graphene is liquid phase exfoliation (LPE). LPE typically involves three steps, which include dispersing graphite in a solvent, exfoliating graphene from graphite and purifying the exfoliated graphene. Exfoliation of graphene may be achieved by electrochemically exfoliating graphene from a graphite anode in an ionic liquid and water mixture, acid exfoliation of graphite to produce solution dispersible graphene oxide flakes or ultrasonication in organic solvents. A disadvantage of LPE methods is that tend to produce graphene flakes which are relatively small in size (less than 1 mm) and require purification from chemical residues, which degrades the electrical and electrochemical properties of the graphene obtained

The Hummers method is (an LPE method) frequently used to prepare graphite oxide (GO). This method typically consists of the steps of oxidising graphite in a mixture of sodium nitrate, potassium permanganate and sulphuric acid and then sonicating the graphite oxide to produce graphene oxide. The graphene oxide is then reduced to produce graphene. However, one drawback of the Hummers' method is that it is relatively complex in that it requires a combination of chemical and mechanical treatments. Moreover, the method utilises chemical acids and produces toxic nitrous gas which are harmful and polluting if they are not handled and disposed of appropriately. A further drawback is that surface defects in reduced graphene are unavoidable. This is significant because the presence of defects reduces the electrical and electrochemical properties graphene.

The thermal decomposition of silicon carbide (SiC) can also be used to produce graphene having 1-3 layers. In this method a SiC substrate is heated at a temperature between 1250° C. and 1450° C. which causes graphene to epitaxially grow on the substrate. While this process allows multi-layered graphene to be produced on a large scale, SiC substrates are relatively expensive and highly specialised equipment and personnel are needed to grow graphene which further increases production costs.

A chemical vapour deposition (CVD) approach can also be employed to produce graphene. CVD methods can be divided into two classes, namely thermal CVD and plasma enhanced CVD. Both thermal and plasma enhanced CVD approaches enable high quality graphene to be produced in large quantities at relatively low cost. However, both require the use of hazardous gaseous carbon precursors and the graphene obtained typically contains defects that degrade the electronic and electrochemical properties of graphene. Furthermore, they require a metallic substrate precursor such as Cu or Ni to enable the graphene formation and growth on them. Removing graphene from the metallic substrate requires still another process.

In light of the above it is an object of embodiments of the disclosure to provide an improved method for producing graphene. In particular, it is an objection of embodiments of the disclosure to provide method for producing graphene which is simple and does not require the use of specialised equipment and personal. It is also an object of embodiments of the disclosure to provide a method which does not require the use of metallic substrates or precursors to prepare graphene or functionalised (doped) graphene. It is another object of embodiments of the disclosure to provide a method for producing graphene which avoids or substantially avoids the use the hazardous chemicals. It is a further object of embodiments of the disclosure to provide an inexpensive method for producing functionalised graphene such as nitrogen-doped graphene. It is yet a further object of embodiments of the disclosure to provide a method for producing hydrophilic graphene. It is yet a further object of embodiments of the disclosure to provide a method for producing graphene at low cost and high production rates.

### SUMMARY

According to a first aspect of the disclosure there is provided a method for producing graphene, the method comprising the steps of providing a polymeric graphene precursor comprising one or more donor atoms, subjecting the polymeric graphene precursor to a bulk thermal heat treatment to produce graphene and subjecting the doped graphene obtained from the thermal heat treatment to at least one or more mechanical exfoliation treatments, wherein the one or more mechanical exfoliation treatments comprises ball milling.

It has been found that the above method is very suitable for producing graphene powder on an industrial scale since it can be produced in a simple, one-step and cost-effective manner, without using transfer processes, highly specialised equipment, catalysts and metal substrate precursors. Moreover, the method enables graphene to be obtained at ambient pressure, with minimal chemical waste and without using harsh chemical conditions, meaning graphene can be produced in a safe and environmentally friendly manner.

In some embodiments the graphene obtained is doped graphene, i.e. graphene structure which contains one or more donor atoms such as nitrogen (N) and sulphur (S). It has been found that the doped graphene exhibits a high degree of hydrophilicity and as a consequence, relative to pristine graphene, the doped graphene exhibits improved wettability and dispersibility in solution which avoids agglomeration. It also enables it to be readily mixed with and incorporated into polymer materials or other fluids which in turn improves the electrical properties of polymer composites, anticorrosion coatings and electrode coatings for storage devices.

The polymeric graphene precursor may comprise a nitrogen-containing polymer, a sulphur-containing polymer, an oxygen-containing polymer, a hydroxyl-containing polymer, a chlorine containing polymer or a mixture thereof. In this way nitrogen-doped graphene, sulphur-doped graphene, oxygen-doped graphene, or chlorine doped graphene can be obtained.

In some embodiments the polymeric graphene precursor may comprise a polyimide. The polyimide may be an aliphatic or aromatic polyimide.

In some embodiments the polymeric graphene precursor may comprise a heterocyclic ring. The heterocyclic ring may comprise one or more donor atoms. In some embodiments the heterocyclic ring may comprise at least two donor atoms. For example, the heterocyclic ring may be an imidazole which comprises two nitrogen atoms. In particular, the polymeric graphene precursor may comprise polybenzimidazole.

The polymeric graphene precursor may comprise a synthetic polymeric graphene precursor since this enables graphene to be produced on a larger scale and in a more reliable and consistent manner. Suitably, the polymeric graphene precursor may be selected from the group comprising polysulfone, polyether sulfone, polyamide, poly(etherimide), polyether ether ketone, polyphenylene sulfide, chlorinated poly(vinyl chloride), polystyrene, epoxy, phenolic resin.

In some embodiments a naturally occurring polymeric graphene precursor such as lignin may be used as the carbon source for graphene.

The polymeric graphene precursor may be in the form of powders or granules, wires, tubes, sheets or blocks. The granules may in the size of 0.1 mm-5 mm to enable rapid heat conduction to the interior part of the material for carbonisation. By subjecting solid polymeric graphene precursors to the heat treatment, the use of gaseous carbon sources which are known to be hazardous can be avoided.

The bulk thermal heat treatment may be carried out in a furnace, suitably a tube furnace. The thermal heat treatment may be carried out at temperatures between 600° C. and 1600° C. In some embodiments the thermal heat treatment may be carried out between 800° C. and 1400° C., suitably at a temperature between 1000° C. and 1200° C. The temperature may be increased incrementally, e.g. at a rate of 10° C. per minute. The temperature may be held a peak temperature for at least 30 minutes. The peak temperature may be between 1000° C. and 1600° C. The graphene thus formed may be allowed to cool naturally. It has been found that when the temperature is controlled at a temperature between 1000° C. and 1200° C. that the material exhibits a D/G ratio of 0.9-2 (as determined by Raman spectroscopy) and that 2D peaks start to appear indicating the formation of graphene. At this temperature range, it has been found that doped graphene is predominantly formed, whereas when the temperature is greater than 1500° C., undoped graphene may be obtained.

The bulk thermal heat treatment may be carried out in the presence of an inert gas. The inert gas may comprise argon, nitrogen, helium or a mixture thereof. The use of an inert gas prevents or at least substantially reduces the level of oxidation as graphene is formed from the thermally decomposed polymeric graphene precursor. This in turn reduces the number of defects in graphene and increases the volume of yield.

In some embodiments, the mechanical exfoliation treatment may comprise ball milling and sonication or ultrasonication treatments. In particular, the graphene may first be ball milled and then sonicated. The graphene may be ball milled for at least 1 hour, up to one week, typically 24 hours. The longer it is milled, the finer it becomes. For example, milling for 1 hour results in graphene flakes of 10s of micrometres, whilst milling for 24 hours enables graphene flakes of around 1 micrometre to be obtained. Various liquids may be used during the ball milling process including the addition of water, alcohol or a mixture thereof. The addition of liquid enables finer graphene powders to be obtained.

The graphene may be sonicated at a frequency of at least 80 kHz, suitably at 80-100 kHz. If the frequency is low, e.g., below, 80 Hz, then Van der Waals' forces among graphene layers are difficult to be overcome meaning powders with reduced quantities of graphene (and increased quantities of graphite) will be obtained which is undesirable.

The graphene may be sonicated for 24 hours or more. If the doped graphene is sonicated for less than 24 hours then powders may be obtained with reduced quantities of graphene since there is insufficient time to break graphite down into graphene.

The graphene may be sonicated in an organic solvent. In particular, the organic solvent may comprise particle dispersion materials such as Dimethyl Sulfoxide (DMSO), 2-Mythel-2-nitrosopropane (NMP) or Dimethylacetamide (DMAC). The solvent may additionally comprise water, alcohol or a mixture thereof.

According to a second aspect of the disclosure there is provided graphene produced according to the method of the first aspect of the disclosure. The graphene according to the second aspect of the disclosure may, as appropriate, comprise any or all of the features described in relation to the first aspect of the disclosure.

The graphene obtained may be doped graphene. In particular the doped graphene may be nitrogen-doped graphene, sulphur-doped graphene, oxygen-doped graphene, chlorine doped graphene or a combination thereof.

The doped graphene may be hydrophilic.

The doped graphene may exhibit a water contact angle of less than 90° (hydrophilic). In particular, the water contact angle may be between 50° and 70°. This is much lower than the water contact angle of undoped graphene (typically >90°) which is hydrophobic.

The doped graphene exhibits a high degree of porosity. In some embodiments the doped graphene comprises 0.01-2 μm pores. A highly porous graphene structure allows it to have many more surface areas thereby making is more suitable for absorbing, attachment, binding, bonding and mixing with other materials. Graphene with a high degree of porosity is difficult to achieve using conventional methods.

The doped graphene may be characterised by a D/G ratio of 0.9-2 as determined by Raman spectroscopy. 2D peaks may be present.

The graphene may comprise 5-30 μm graphene flakes.

According to a third aspect of the disclosure there is provided the use of the graphene produced by the method according to the first aspect of the disclosure in a filter, in rubber, in a carbon fibre composite or in metal or metal alloys. The doped graphene may, as appropriate include any or all of the features described in relation to the first aspect and second aspect of the disclosure.

### BRIEF DESCRIPTION OF THE DRAWINGS

In order that the disclosure may be more clearly understood one or more embodiments thereof will now be described, by way of example only, with reference to the accompanying drawings, of which:

FIG. 1 is a diagram showing the method for producing doped graphene;

FIGS. 2A-2D show Raman spectra of graphene between 600° C. and 1200° C.; and

FIGS. 3A-3B show XPS spectra confirming the presence of doped graphene.

FIG. 4 shows graphene produced according to the method shown in FIG. 1.

### DETAILED DESCRIPTION

As best shown in FIG. 1, the first step in the method for producing doped graphene is to subject a graphene precursor to a bulk thermal heat treatment. In this embodiment, the graphene precursor is a nitrogen-containing polymer such as polyimide. The polyimide is introduced into a tube furnace containing an inert gas and the decomposition of polyimide powder starts at a temperature above 300° C. At this temperature polyimide degrades to produce polyimide particles having an average diameter of around 2 mm, CO₂, CO and vapour originating from the imide groups, with CO becoming predominant at temperatures above 400° C. The inert gas in this embodiment is argon, although other inert gases such as nitrogen and helium can be used as part of an inert gas mixture. The released gases and argon provide protection for the rest of the fragments including an aryl-CO bond and a metastable intermediate nitrogen-compound, which acts as the N-dopant. The temperature is then gradually increased to 600° C., 800° C., 1000° C. and 1200° C. at a 10° C./minute to produce graphene. Next, the graphene obtained from the thermal heat treatment is ball milled for a period of 24 hours to produce uniform 10-30 μm graphene flakes. Once ball milling is complete, the graphene flakes are then mixed with an organic solvent such as Dimethylacetamide (DMAc) at 96% volume and sonicated (using an ultrasonic reactor—Elmasonic P70H, refrigerating circular, keeping the temperature at around 10° C.) at 80 kHz frequency for a further 24 hours.

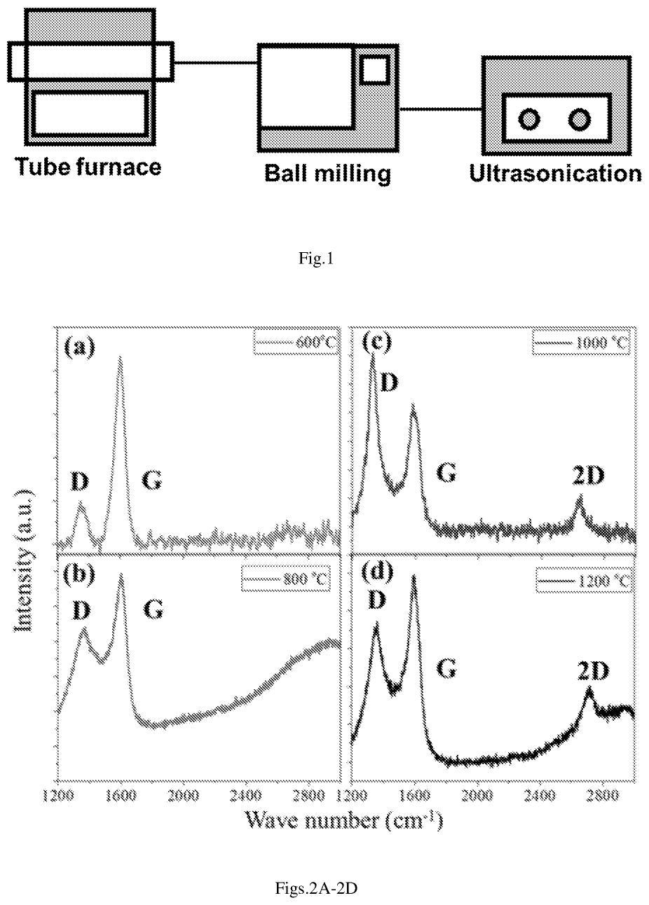

To confirm the production of n-doped graphene. the decomposed products were analysed using Raman spectroscopy (model Reneshaw 200) with a 514 nm excitation wavelength in air. As the Raman spectra mapping shows in FIG. 2A, the polyimide is fully carbonized and part of the thermal energy gradually stimulates the crystallisation of graphene when the temperature exceeds 600° C. The G peak at 1600 cm⁻¹ and D peaks are activated by double resonance at the edge of the grain boundary at 1350 cm⁻¹ and it is understood that graphene crystallite size is proportional to the ratio between D and G. It can be seen from a comparison of FIGS. 2A and 2B that the D peak increases with an increase in temperature from 600° C. to 800° C. and that the D/G ratio increases from 0.23 to 0.73. As the temperature increases from 800° C. to 1000° C. the D/G increases to 1.21 and anew 2D peak appears (FIG. 2C) which is indicative of the formation of 2-dimensional graphene layers. When the temperature is increased to 1200° C., the D/G ratio falls to about 0.93 and a 2D/G ratio of about 0.25 is obtained which together signify that graphene with a high degree of uniformity has been produced.

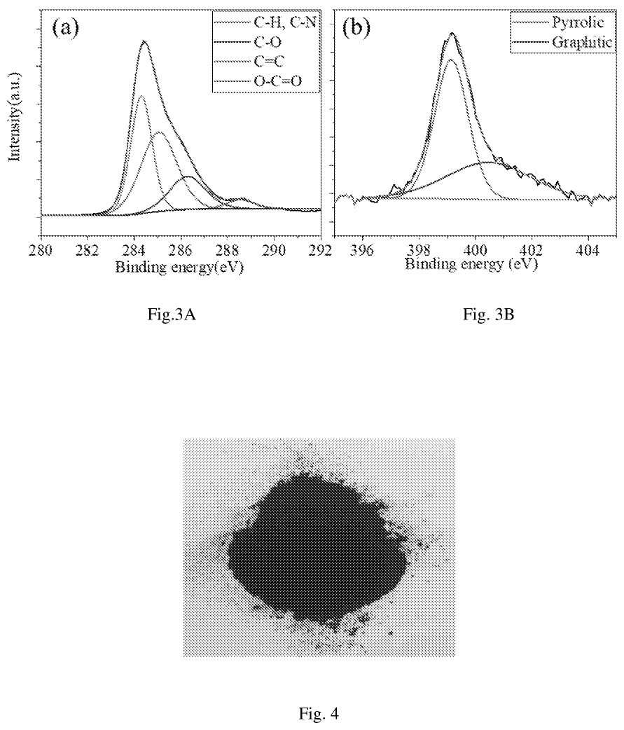

The production of graphene was also confirmed using x-ray photoelectron spectroscopy (XPS), model Kratos Axis Ultra, with a monochromatic Al K X-ray source, using 20 eV with a hemispherical energy analyser positioned along the surface norm. As temperatures were increased to above 600° C., this led to the reorganisation and growth of nano-crystalline graphene. FIGS. 3A and 3B show spectra of graphene samples following the heat treatment at 1200° C. In particular, FIG. 3B shows that the dominant pyrrolic product (2.5%) at 399 eV is mixed with graphitic structures (1.4%) detected from N-doped graphene having a sp₂ C═C bond at 284.3 eV (FIG. 3A).

The obtained graphene was also subjected to a water contact angle test in order to determine its hydrophilicity, using a contact angle analyser DSA25 from Kruss. The results of the water contact angle test showed that the graphene had a water contact angle of 60°. This is much less than conventional graphene which typically has a water contact angle >90° (i.e. hydrophobic). The improved hydrophilicity is significant because it promotes better mixing with polymers and makes it more suitable for use in filtration applications for example. Moreover, because the graphene is hydrophilic this leads to improved dispersibility in solution and avoids or substantially reduces agglomeration. As a result, uniform enhancement of materials can be obtained which leads to improvements in the mechanical and electrical properties of various products, such as polymer composites, anticorrosion coatings and electrode coatings for different energy storage devices.

The one or more embodiments are described above by way of example only. Many variations are possible without departing from the scope of protection afforded by the appended claims.

1. A method for producing graphene, the method comprising:
providing a polymeric graphene precursor comprising one or more donor atoms;
subjecting the polymeric graphene precursor to a bulk thermal heat treatment to obtain graphene; and
subjecting the graphene obtained from the bulk thermal heat treatment to one or more mechanical exfoliation treatments, wherein the one or more exfoliation treatments comprise ball milling.

2. The method according to claim 1, wherein the graphene comprises doped graphene with one or more of non-carbon elements including one or more of nitrogen, sulphur, oxygen, or chlorine.

3. The method according to claim 1, wherein the polymeric graphene precursor comprises a nitrogen-containing polymer, a sulphur-containing polymer, an oxygen-containing polymer, a hydroxyl-containing polymer, a chlorine containing polymer, or a mixture thereof.

4. The method according to claim 1, wherein the polymeric graphene precursor comprises polyimide, polybenzimidazole, or is selected from the group comprising polysulfone, polyether sulfone, polyamide, poly(etherimide), polyether ether ketone, polyphenylene sulfide, chlorinated poly(vinyl chloride), polystyrene, epoxy, phenolic resin, and lignin.

5. (canceled)

6. (canceled)

7. The method according to claim 1, wherein the bulk thermal heat treatment is carried out at a temperature between 600° C. and 1600° C.

8. The method according to claim 1, wherein the bulk thermal heat treatment is carried out at a temperature between 800° C. and 1200° C.

9. The method according to claim 1, wherein during the bulk thermal heat treatment the temperature is increased at a rate of 10° C. per minute.

10. (canceled)

11. The method according to claim 1, wherein the bulk thermal heat treatment is performed in the presence of an inert gas.

12. (canceled)

13. The method according to claim 1, wherein the graphene is ball milled for at least 1 hour.

14. The method according to claim 1, wherein the one or more mechanical exfoliation treatments comprise ball milling and sonication.

15. The method according to any of claim 14, wherein the graphene is sonicated at a frequency of 80 kHz-100 kHz.

16. The method according to claim 14, wherein the graphene is sonicated for at least 24 hours.

17. The method according to claim 14, wherein the graphene is sonicated in an organic solvent.

18. (canceled)

19. Graphene produced according to the method of claim 1.

20. The graphene according to claim 19, wherein the graphene is doped graphene and is hydrophilic.

21. The graphene according to claim 20, wherein the doped graphene exhibits a water contact angle between 50° and 70°.

22. The graphene according to claim 20, wherein the doped graphene is porous and comprises 0.01-2 μm pores.

23. The graphene according to claim 20, wherein the doped graphene is characterised by a D/G ratio of 0.9-2.

24. The graphene according claim 19, wherein the graphene comprises 10-30 μm graphene flakes.

25. A method, comprising:
using the graphene produced by the method according to claim 1 in a filter, in rubber, in a carbon fibre composite, or in metal or metal alloys.
